(19) United States
(12) Patent Application Publication
(10) Pub. No.: US 2006/0280190 A1
(43) Pub. Date: Dec. 14, 2006

(54) UPnP mirroring systems and methods

(75) Inventors: Po Hsu Chen, Taipei (TW); Bor Lun Chang, Taipei (TW)

Correspondence Address: QUINTERO LAW OFFICE, 1617 BROADWAY, 3RD FLOOR, SANTA MONICA, CA, 90404, US

(73) Assignee: WISTRON CORP., TAIPEI HSIEN (TW)

(21) Appl. No.: 11/258,773

(22) Filed: Oct. 25, 2005

(30) Foreign Application Priority Data
Jun. 14, 2005 (TW) TW94119634

(51) Int. Cl. G06F 15/16; H04L 12/56; H04L 12/28

(52) U.S. Cl. 370/401; 370/389; 709/249

(57) ABSTRACT

UPnP mirroring systems and methods. A UPnP mirroring system comprises a control point, at least one UPnP device, a mirroring agent, and at least one remote control device. The control point and the UPnP device are coupled to a first network. The remote control device is coupled to a second network. The mirroring agent is coupled to the first and second networks, and emulates the presence of the control point on the second network. The remote control device communicates with the UPnP device via the emulated control point on the second network.

### BACKGROUND

The invention relates generally to data communication, and, more particularly, to UPnP (Universal Plug and Play) mirroring systems and methods that mirror control points in different networks.

In digitally equipped environments, a control point uses a specific technology, such as UPnP, to connect with a content source, such as a media server, and acquire content directory service therefrom. The control point selects a specific content item, and specifies a specific device, such as a media renderer for playback.

UPnP architecture is a device interaction standard employed in digitally equipped environments, such as digital homes. UPnP architecture defines network connection and communication between point to point devices, comprising intelligent apparatuses, wireless devices, computer systems, and devices with communication capability. The devices in UPnP architecture may be control devices (CD), and control points (CP). Each device may play a control device and a control point, simultaneously.

Network operations for devices in UPnP architecture comprise addressing, discovery, description, control, eventing, and presentation. The details of these network operations can be referred to UPnP definition, and are omitted herefrom. When a UPnP control device connects to a network, it sends messages showing available services via the network. Other apparatuses, such as control points in the network receive device usability information, or locate the UPnP device by sending queries via the network. Once a device is found by a control point (by receiving information or querying), the specific descriptions of the device and the services are acquired. The control point can also search web pages representing the device. Thus, the control point sends a request to use the device according to the descriptions and web pages. The control device returns to the request from the control point, executes actions, and returns messages to the control point, providing device status information.

As described, UPnP architecture is a device interaction standard employed in digitally equipped environments, such as digital homes. Thus, UPnP architecture is designed for UPnP devices in the same network segment. If devices are in different network segments, device communication and control are not supported under conventional UPnP architecture, reducing applicability thereof.

### SUMMARY

UPnP mirroring systems and methods are provided, whereby devices in different network segments can communicate and control each other.

An embodiment of a UPnP mirroring system comprises a control point, at least one UPnP device, a mirroring agent, and at least one remote control device. The control point and the UPnP device are coupled to a first network. The remote control device is coupled to a second network. The mirroring agent is coupled to the first and second networks, and emulates a presence of the control point on the second network. The remote control device communicates with the UPnP device via the emulated control point in the second network.

In an embodiment of an UPnP mirroring method, a control point coupled to a first network is communicated with, in which at least one UPnP device couples to the first network. Presence of the control point is emulated on a second network. The UPnP device is communicated with via the emulated control point in the second network.

UPnP mirroring methods may take the form of program code embodied in tangible media. When the program code is loaded into and executed by a machine, the machine becomes an apparatus for practicing the disclosed method.

### DESCRIPTION OF THE DRAWINGS

The aforementioned features and advantages will become apparent by referring to the following detailed description with reference to the accompanying drawings, wherein:

FIG. 1 is a schematic diagram illustrating an embodiment of a UPnP mirroring system; and

FIG. 2 is a flowchart of an embodiment of a UPnP mirroring method.

### DESCRIPTION

UPnP mirroring systems and methods are provided.

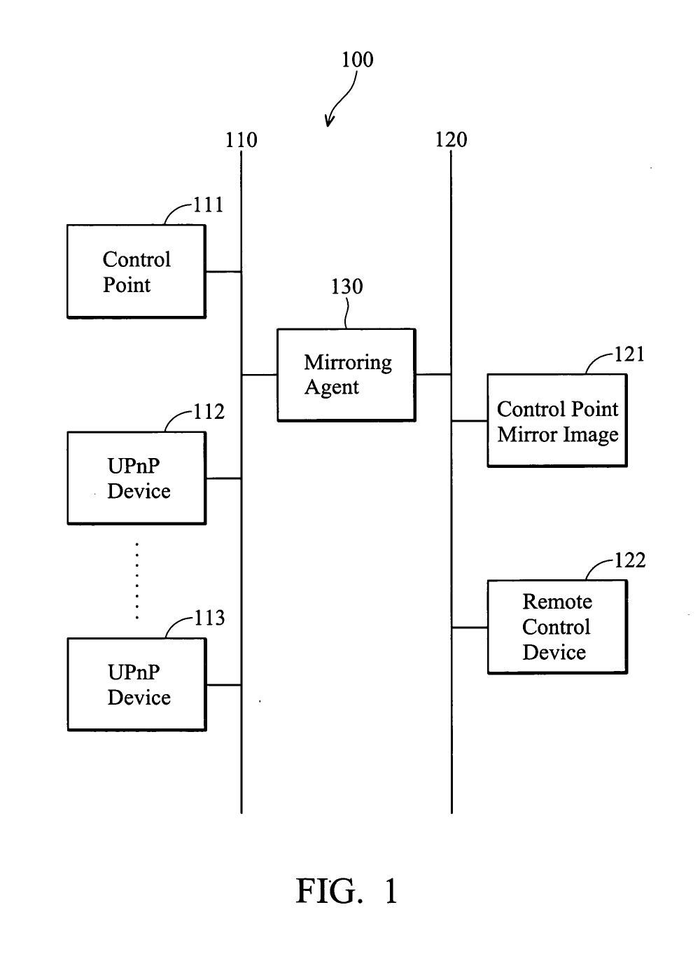

FIG. 1 is a schematic diagram illustrating an embodiment of a UPnP mirroring system, in which UPnP mirroring system 100 provides device communication capability between network segments. The UPnP mirroring system 100 comprises a first network 110 and a second network 120. The first network 110 may be a home network. A control point 111, a plurality of UPnP devices (112 and 113), and a mirroring agent 130 connect via the first network 110. The control point 111 and the UPnP devices may be intelligent apparatuses, wireless devices, computer systems, and devices with communication capability. The UPnP devices (112 and 113) provide services to the control point and related devices in the network.

The mirroring agent 130 has an interface (not shown), supporting various protocols such as HTTP (Hypertext Transmission Protocol) and WAP (Wireless Application Protocol). The mirroring agent 130 can use the interface to connect with a second network 120 via specific devices such as routers, gateways and modems to receive data from devices in the second network 120. The second network 120 may be a telecommunication network or Internet. The mirroring agent 130 discovers the control point 111 in the first network 110, and emulates the presence of the control point 111 on the second network 120. That is the mirroring agent 130 establishes a mirror image 121 of the control point 111 on the second network 120. A remote control device 122 such as computer system and mobile phone in the second network 120 can use a browser to communicate with the UPnP device in the first network 110 via the mirror image 121, thus performing related control such as transmission of requests to the UPnP device, and reception of corresponding responses by the UPnP device.

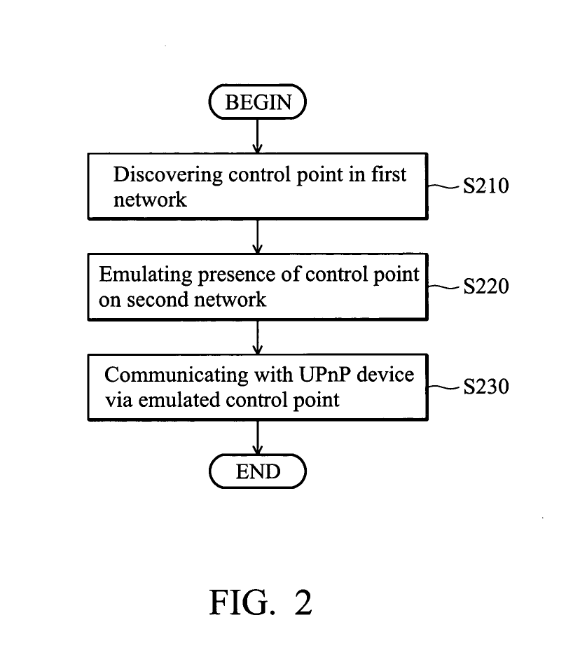

FIG. 2 is a flowchart of an embodiment of a UPnP mirroring method.

In step S210, the mirroring agent 130 discovers the control point 111 in the first network 110, and communicates therewith. It is understood that the control point 111 and the UPnP devices (112 and 113) perform network operations comprising addressing, discovery, description, control, eventing, and presentation according to UPnP architecture. The details of these network operations can be referred to UPnP definition, and are omitted herefrom. In step S220, the mirroring agent 130 emulates the presence of the control point 111 on the second network 120, thus generating the mirror image 121 of the control point 111. That is all operations between the control point 111 and the UPnP devices (112 and 113) are duplicated on the mirror image 121. In step S230, the UPnP devices are communicated with via the emulated control point (mirror image 121) in the second network 120. It is understood that control instruction and data transmission between the UPnP devices and the remote control device 122 is transmitted via the control point 111 in the first network 110, and related information is recorded in the control point 111. Thus, remote control devices such as computer systems and mobile phones can control UPnP devices in different network segments.

UPnP mirroring systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A UPnP mirroring system, comprising:
a control point coupled to a first network;
at least one UPnP device coupled to the first network;
a mirroring agent coupled to the first network and a second network, emulating a presence of the control point on the second network; and
at least one remote control device coupled to the second network, communicating with the UPnP device via the emulated control point in the second network.

2. The system of claim 1 wherein the remote control device transmits at least one request to the UPnP device in the first network via the emulated control point in the second network, and the UPnP device receives a corresponding response.

3. The system of claim 1 wherein the second network comprises a telecommunication network, and the remote control device controls the UPnP device in the first network via the emulated control point using the telecommunication network.

4. The system of claim 1 wherein the second network comprises an Internet, and the remote control device controls the UPnP device in the first network via the emulated control point using a browser.

5. The system of claim 4 wherein the mirroring agent further comprises an interface supporting at least one protocol to connect with the second network to receive data from the remote control device.

6. The system of claim 5 wherein the protocol comprises HTTP (Hypertext Transmission Protocol) or WAP (Wireless Application Protocol).

7. A UPnP mirroring method for use in a first network and a second network, the first network connected with a control point, at least one UPnP device and a mirroring agent, the second network connected with at least one remote control device, the method comprising:
the mirroring agent emulating the presence of the control point on the second network; and
the remote control device communicating with the UPnP device via the emulated control point in the second network.

8. The method of claim 7 further comprising:
the remote control device transmitting at least one request to the UPnP device in the first network via the emulated control point in the second network; and
the UPnP device receiving a corresponding response.

9. The method of claim 7 wherein the second network comprises a telecommunication network, and the method further comprises the remote control device controlling the UPnP device in the first network via the emulated control point using the telecommunication network.

10. The method of claim 7 wherein the second network comprises an Internet, and the method further comprises the remote control device controlling the UPnP device in the first network via the emulated control point using a browser.

11. The method of claim 10 further comprising the mirroring agent receiving data from the remote control device via an interface supporting at least one protocol.

12. The method of claim 11 wherein the protocol comprises HTTP (Hypertext Transmission Protocol) or WAP (Wireless Application Protocol).

13. A UPnP mirroring method, comprising:
communicating with a control point coupled to a first network, in which the first network is further connected with at least one UPnP device;
emulating a presence of the control point on a second network; and
communicating with the UPnP device via the emulated control point in the second network.
